(19) United States
(12) Patent Application Publication
(10) Pub. No.: US 2009/0127445 A1
(43) Pub. Date: May 21, 2009

(54) OPTICAL ENCODER

(75) Inventor: Yasuhiro Matsutani, Fukuoka (JP)

Correspondence Address: SUGHRUE-265550, 2100 PENNSYLVANIA AVE. NW, WASHINGTON, DC, 20037-3213, US

(73) Assignee: KABUSHIKI KAISHA YASKAWA DENKI, Kitakyushu-shi (JP)

(21) Appl. No.: 12/063,893

(22) PCT Filed: Aug. 4, 2006
(86) PCT No.: PCT/JP2006/315468

§ 371 Date: Feb. 15, 2008

(30) Foreign Application Priority Data
Aug. 18, 2005 (JP) 2005-237349

(51) Int. Cl. G01D 5/34

(52) U.S. Cl. 250/231.1

(57) ABSTRACT

There is provided an optical encoder increasing an area of bringing a rotation disk and a hub into contact with each other, capable of drawing air at faces of the rotation disk and the hub brought into contact with each other even when there is not a center hole portion at the rotation disk, having a high adhering strength of the rotation disk and promoting a reliability. In an optical encoder including a rotation disk (1) having a slit pattern for passing light between a light receiving portion and a light emitting portion, and a hub (2) for fixing the rotation disk (1) to a rotating shaft (6), there is constructed a constitution in which the hub (2) includes a first groove (4) formed in a shape of a concentric circle at an end portion on a side of a face thereof attached to the rotation disk (1) and a second groove (5) formed to be orthogonal to the first groove (4) in a normal line direction thereof, and an adhering agent (3) for fixedly attaching the rotation disk (1) and the hub (2) is filled in the first groove (4) and the second groove (5) of the hub (2). Thereby, air at faces of the rotation disk (1) and the hub (2) brought into contact with each other can be drawn, and therefore, the adhering strength of the rotation disk (1) is increased and also the reliability is promoted.

### TECHNICAL FIELD

The present invention relates to an optical encoder used in a servo system of, for example, a robot, a semiconductor fabricating apparatus, an NC machine tool or the like and detecting a rotational position and a rotational speed of a motor.

### BACKGROUND ART

In a background art, for example, in a servo system of a robot, a semiconductor fabricating apparatus, an NC machine tool or the like, a high function AC servo motor is used and an optical rotary encoder having a high resolution is used for detecting a rotational position, a rotational speed or the like of the motor.

FIGS. 3A and 3B show a constitution of an essential portion of a rotating member of an optical encoder of a background art, FIG. 3A is a side sectional view taken along a line A-A of FIG. 3B, and FIG. 3B is a front view viewing FIG. 3A from a side of a rotation disk. In FIG. 3A, numeral 21 designates a rotation disk of an optical encoder, numeral 22 designates a hub for receiving the rotation disk 21, notation 22a is a projected portion formed at a front end of the hub 22, and notation 22b designates a groove formed on a circumference on a side of a face of the hub 22 attached to the rotation disk 21, which is provided to be disposed between an outer peripheral face and the projected portion 22a of the hub 22.

In such a constitution, the rotation disk 21 is supported in a state of inserting the projected portion 22a of the hub into a hole portion provided at a center of the rotation disk 21, and the hub 22 and the rotation disk 21 are fixed by filling an adhering agent 23 to between the hub 22 and the rotation disk 21 and to the groove 22b provided at the hub 22. Further, otherwise, there is a constitution of forming a groove in a circumferential direction on a side of the face of the rotation disk attached to a hub, and an adhering agent is filled into the groove to thereby fix the rotation disk and the hub (refer to, for example, Patent Reference 1).
Patent Reference 1: JP-A-2004-163145 (specification page 3, FIG. 3)

### DISCLOSURE OF THE INVENTION

### Problems that the Invention is to Solve

In fixing the rotation disk of the optical encoder of the background art, the fixing is carried out only by the adhering agent, and therefore, when an area of bringing the rotation disk and the hub into contact with each other is not made to be large, there poses a problem that an adhering strength of the adhering agent is low and a reliability is deteriorated. Further, when a rotating shaft of a motor is adhered to be fixed to the hub center hole portion previously to be hermetically sealed and there is not the center hole portion at the rotation disk, air cannot be drawn from the center hole portion of the rotation disk. An air layer is produced at faces of the rotation disk and the hub brought into contact with each other. Therefore, there also poses a problem that an extraneous amount of the adhering agent is nonuniformly spread, the rotation disk is floated up from the hub, and reliability of the adhering force is further deteriorated. When the problem is posed, at the rotation disk of the optical encoder, there is brought about a phenomenon that warpage or face oscillation is increased and a detecting accuracy of the encoder is deteriorated.

The invention has been carried out in view of the problem, and it is an object thereof to provide an optical encoder in which an area of bringing a rotation disk and a hub into contact with each other is increased and even when a center hole portion is not provided at the rotation disk, air at faces of the rotation disk and the hub brought into contact with each other can be drawn, having a high adhering strength of the rotation disk and promoting a reliability.

### Means for Solving the Problems

In order to resolve the above-described problem, according to first aspect of the invention, an optical encoder includes a rotation disk having a slit pattern for passing light between a light receiving portion and a light emitting portion, and a hub for fixing the rotation disk to a rotating shaft, wherein the hub includes at least one first groove formed in a shape of a concentric circle at an end portion on a side of a face thereof attached to the rotation disk and at least one second groove formed to be orthogonal to the first groove in a normal line direction thereof, and wherein the first groove and the second groove of the hub is filled with an adhering agent for fixedly attaching the rotation disk and the hub.

According to a second aspect of the invention, the optical encoder provides that the second groove of the hub is constituted by a recessed shape or a V-like shape.

### ADVANTAGE OF THE INVENTION

According to the first aspect of the invention, the optical encoder includes the rotation disk having the slit pattern for passing light between the light receiving portion and the light emitting portion and the hub for fixing the rotation disk to the rotating shaft, there is the constitution in which the hub includes at least the first groove formed in the shape of the concentric circle at the end portion on the side of the face attached to the rotation disk and at least the second groove formed to be orthogonal to the first groove in the normal line direction. Therefore, an area of bringing the rotation disk and the hub into contact with each other can be increased, and air stored between the rotation disk and the hub can be drawn. As a result thereof, the adhering strength of the rotation disk is increased and the reliability is promoted.

Further, according to the second aspect of the invention, there is the constitution in which the shape of the groove of the hub is constituted by the recessed shape or the V-like shape. Therefore, air stored between the rotation disk and the hub can firmly be drawn. As a result thereof, the adhering strength of the rotation disk is increased and the reliability is promoted.

### BRIEF DESCRIPTION OF THE DRAWINGS

FIGS. 1A and 1B illustrate a constitution of an essential portion of a rotating member of an optical encoder according to an embodiment of the invention, FIG. 1A is a side sectional view taken along a line A-A of FIG. 1B, and FIG. 1B is a front view viewing FIG. 1A from a side of a rotation disk.

FIG. 2 is a view of a structure of the optical encoder.

FIGS. 3A and 3B illustrate a constitution of an essential portion of a rotating member of an optical encoder of a background art, FIG. 3A is a side sectional view taken along a line A-A of FIG. 3B, and FIG. 3B is a front view viewing FIG. 3A from a side of a rotation disk.

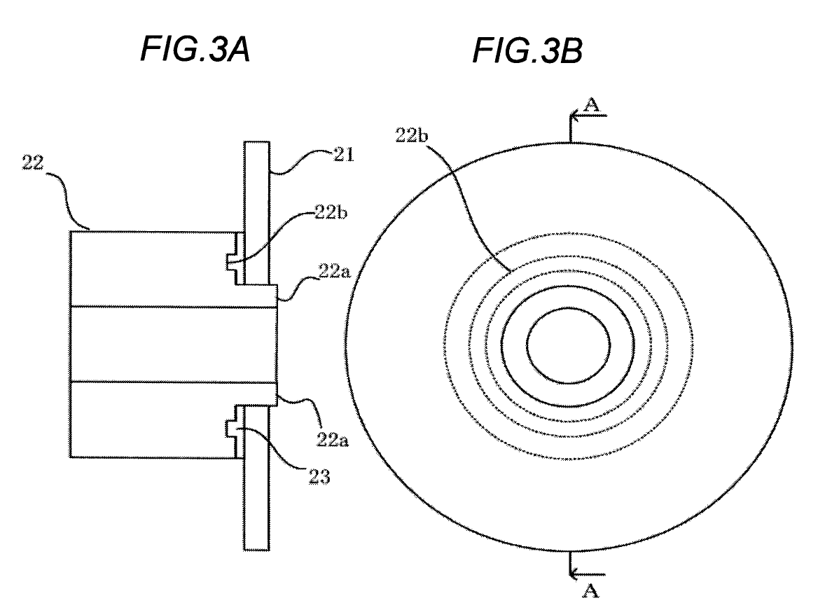

### DESCRIPTION OF REFERENCE NUMERALS AND SIGNS

1. rotation disk
2. hub
3. adhering agent
4. first groove
5. second groove
6. rotating shaft
7. light receiving device
8. light emitting device
9. fixed slit
10. circuit board
21. rotation disk
22. hub
22a. projected portion
22b. groove portion
23. adhering agent

### BEST MODE FOR CARRYING OUT THE INVENTION

An embodiment of the invention will be explained in reference to the drawings as follows.

### Embodiment 1

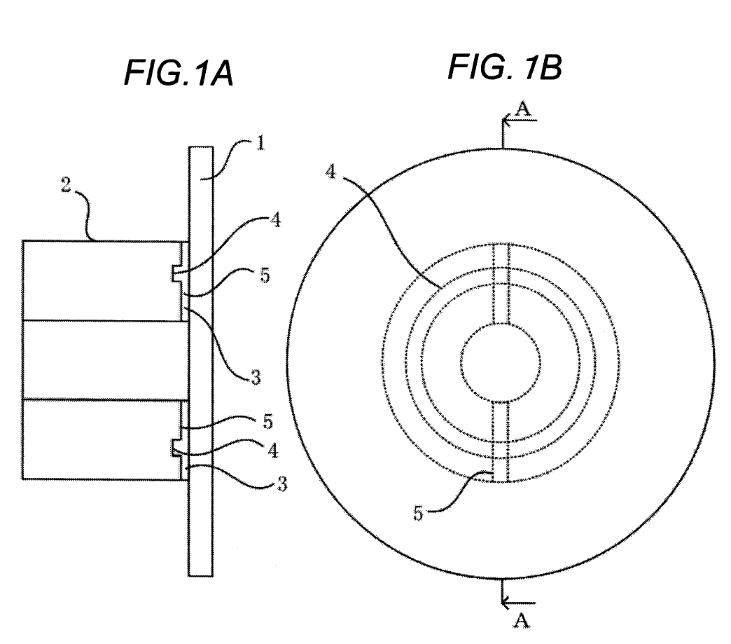

FIGS. 1A and 1B illustrate a constitution of an essential portion of a rotating member of an optical encoder according to the embodiment of the invention, FIG. 1A is a side sectional view taken along a line A-A of FIG. 1B, and FIG. 1B is a front view viewing FIG. 1A from a side of a rotation disk. Further, an explanation will be omitted of constituent elements of the invention the same as those of the background and constituent elements different therefrom will be explained.

In FIG. 1A, numeral 1 designates the rotation disk, numeral 2 designates the hub, numeral 3 designates the adhering agent, numeral 4 designates the first groove, and numeral 5 designates the second groove.

Constituent elements of the invention differ from those of the background art as follows.

That is, there is a constitution in which the hub 2 includes the first groove 4 formed in a shape of a concentric circle at an end portion on a side of a face thereof attached to the rotation disk 1 and the second groove 5 a single one of which is formed to be orthogonal to the first groove 4 in a normal line direction thereof, and the adhering agent 3 for fixedly attaching the rotation disk 1 and the hub 2 is filled to the first groove 4 and the second groove 5.

Further, a shape of the second groove 5 of the hub is constituted by a recessed shape or a V-like shape.

A method of integrating a portion of a rotating member of the optical encoder will be explained as follows.

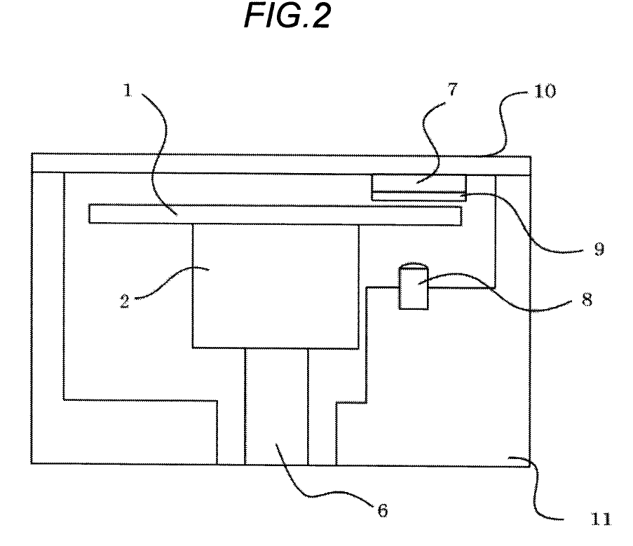

FIG. 2 is a view of a structure of the optical encoder.

In FIG. 2, numeral 6 designates the rotating shaft, numeral 7 designates the light receiving device, numeral 8 designates the light emitting device, numeral 9 designates the fixed slit, and numeral 10 designates the circuit board.

First, the hub 2 is inserted to be fixed to the rotating shaft 6 as a jig and the adhering agent 3 is coated on an attaching face of the rotation disk 1. The rotation disk 1 is mounted the hub and is temporarily fixed, thereafter, the rotating shaft 6 of the jig is slowly rotated. At this occasion, the rotation disk 1 is completely fixed to the hub 2 by carrying out centering by utilizing a slit pattern of the rotation disk 1, using an optical apparatus and exerting a force to an outer periphery of the rotation disk 1 such that an eccentric amount of the slit pattern is in line with a standard.

The embodiment of the invention is configured by a constitution of adding the second groove 5 orthogonal to the first groove 4 in the normal line direction to the first groove 4 formed at the face of the hub 2 brought into contact with the rotation disk 1. Thus, even when the rotation disk 1 which is not provided with the center hole portion is fixedly attached to the hub 2, the extraneous adhering agent at the first groove 4 by storing air is moved from the first groove 4 to the second groove 5 to be able to produce an uniform adhering layer. Therefore, the adhering agent is not unevenly distributed, the adhering strength can be increased and the reliability can be promoted.

### INDUSTRIAL APPLICABILITY

According to the optical encoder of the invention, the optical encoder is applicable to detecting a rotational position, a rotational speed or the like needing a high resolution of an AC servo motor used as a drive source of a servo system of a robot, a semiconductor fabricating apparatus, an NC machine tool or the like.

1. An optical encoder comprising:
a rotation disk having a slit pattern for passing light between a light receiving portion and a light emitting portion; and
a hub for fixing the rotation disk to a rotating shaft,
wherein the hub includes,
at least one first groove formed in a shape of a concentric circle with the hub at an end portion on a side of a face thereof attached to the rotation disk, and
at least one second groove formed to be orthogonal to the first groove in a normal line direction of the first groove, and
wherein the first groove and the second groove of the hub is filled with an adhering agent for fixedly attaching the rotation disk and the hub.

2. The optical encoder according to claim 1,
wherein the second groove of the hub is formed by a recessed shape or a V-like shape.
